(19) United States
(12) Patent Application Publication
(10) Pub. No.: US 2020/0269614 A1
(43) Pub. Date: Aug. 27, 2020

(54) ROLL PAPER STORAGE STRUCTURE AND IMAGE FORMING DEVICE

(71) Applicants: CITIZEN WATCH CO., LTD., Tokyo (JP); CITIZEN SYSTEMS JAPAN CO., LTD., Tokyo (JP)

(72) Inventors: Masakazu MATSUI, Nakano-ku, Tokyo, (JP); Katsutoshi MUKAIJIMA, Higashikurume-shi, Tokyo (JP); Yasuyuki MORI, Higashikurume-shi, Tokyo (JP)

(21) Appl. No.: 16/649,657

(22) PCT Filed: Sep. 25, 2018
(86) PCT No.: PCT/JP2018/035452

§ 371 Date: Mar. 22, 2020

(30) Foreign Application Priority Data
Sep. 27, 2017 (JP) 2017-185765

(51) Int. Cl. B41J 15/04; B41J 3/407; B65H 16/02; B65H 16/06

(52) U.S. Cl. CPC B41J 15/04; B65H 16/06; B65H 16/028; B41J 3/4075

(57) ABSTRACT

An roll paper storage structure includes a casing (body) configured to detachably support a first shaft to which a first roll paper (label roll paper) is set, a first storage portion provided in the casing (body) and configured to store at least a part of the first roll paper (label roll paper) set to the first shaft, and a supporting member (attachment) configured to be attachable to the first storage portion and to support an outer circumferential surface of a second roll paper (normal roll paper) that is not set to the first shaft.

### CROSS-REFERENCE TO RELATED APPLICATION

This application is based upon and claims the benefit of priority from Japanese Patent Application No. 2017-185765 filed on Sep. 27, 2017, the entire disclosure of which is incorporated herein by reference.

### TECHNICAL FIELD

The present disclosure relates to a roll paper storage structure and an image forming device.

### BACKGROUND ART

Two types of image forming devices are commonly known in the art. One uses a label roll paper while the other uses a normal roll paper. The label roll paper includes a plurality of labels attached on a paper mount having a belt shape. The label roll paper is supported by a shaft and housed within the device. The normal roll paper does not include labels. The normal roll paper is housed within the device with the outer circumferential surface supported.

Also, it is known in the art that an image forming device is manufactured by selecting a roll paper unit from a first roll paper unit for proving the normal roll paper or a second roll paper unit for providing the label roll paper (see Patent Literature: JP 2001-341371 A, for example).

### SUMMARY

However, the image forming device disclosed in Patent Literature I has the following issue. Each of the roll paper units is unitized for the roll paper to be stored and includes exclusive elements or parts such as a roll paper cover, a paper guide mechanism so that the elements cannot be commonly used for both of the first and second paper units.

An object of the present disclosure is to provide a roll paper storage structure and an image forming device capable of using common elements or parts applicable to both of a label roll paper and a normal roll paper with a simple configuration.

A roll paper storage structure and an image forming device according to the present disclosure include a casing configured to detachably support a first shaft to which a first roll paper is set, a first storage portion provided in the casing and configured to store at least a part of the first roll paper set to the first shaft, and a supporting member configured to be attachable to the first storage portion and to support an outer circumferential surface of a second roll paper that is not set to the first shaft.

### BRIEF DESCRIPTION OF DRAWINGS

FIG. 1 is a perspective view illustrating an image forming device according to a first embodiment of the present disclosure when a cover is closed.

FIG. 2 is a perspective view illustrating the image forming device according to the first embodiment without an attachment when the cover is opened.

FIG. 3 is a cross-sectional view illustrating the image forming device according to the first embodiment without the attachment.

FIG. 4 is a perspective view illustrating the image forming device according to the first embodiment with the attachment when the cover is open.

FIG. 5 is a perspective view illustrating the attachment according to the first embodiment.

FIG. 6 is a cross-sectional view illustrating the image forming device according to the first embodiment with the attachment.

FIG. 7 is a perspective view illustrating a second or auxiliary shaft according to the first embodiment.

FIG. 8 is a perspective view illustrating a partition plate according to the first embodiment.

FIG. 9 is a cross-sectional view illustrating a static elimination sheet according to a modification of the first embodiment.

FIG. 10 is a cross-sectional view illustrating an image forming device according to a second embodiment with an attachment.

### DESCRIPTION OF EMBODIMENTS

Hereinafter, embodiments of a roll paper storage structure and an image forming device according to the present disclosure will be described with reference to a first embodiment and a second embodiment shown in the figures.

### First Embodiment

First, the configurations in the first embodiment will be described. The roll paper storage structure and the image forming device in the first embodiment are applied to a thermal printer. Hereinafter, the first embodiment will be described with headings “Configuration of Image Forming Device without Attachment”, “Configuration of Image Forming Device with Attachment”, “Configuration of Auxiliary Shaft”, and “Configuration of Partition Plate”.

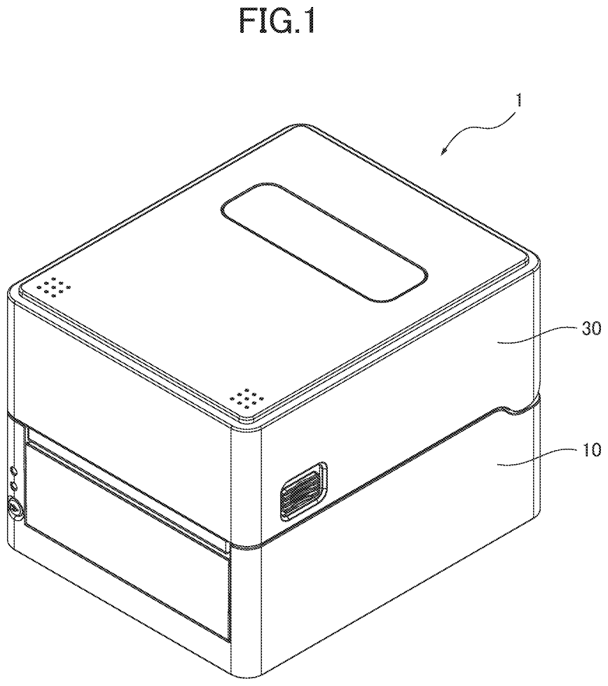

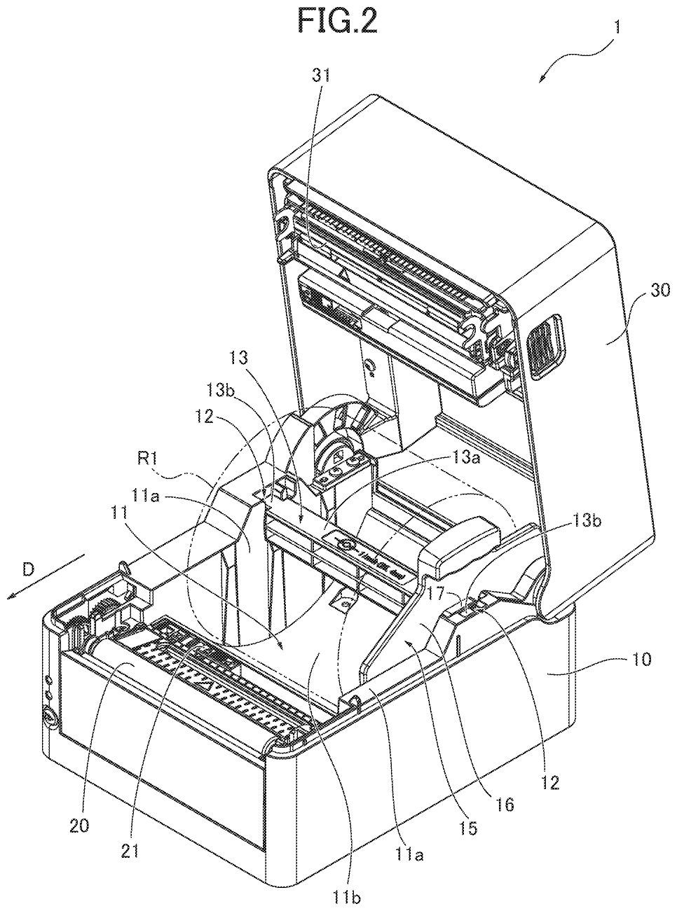

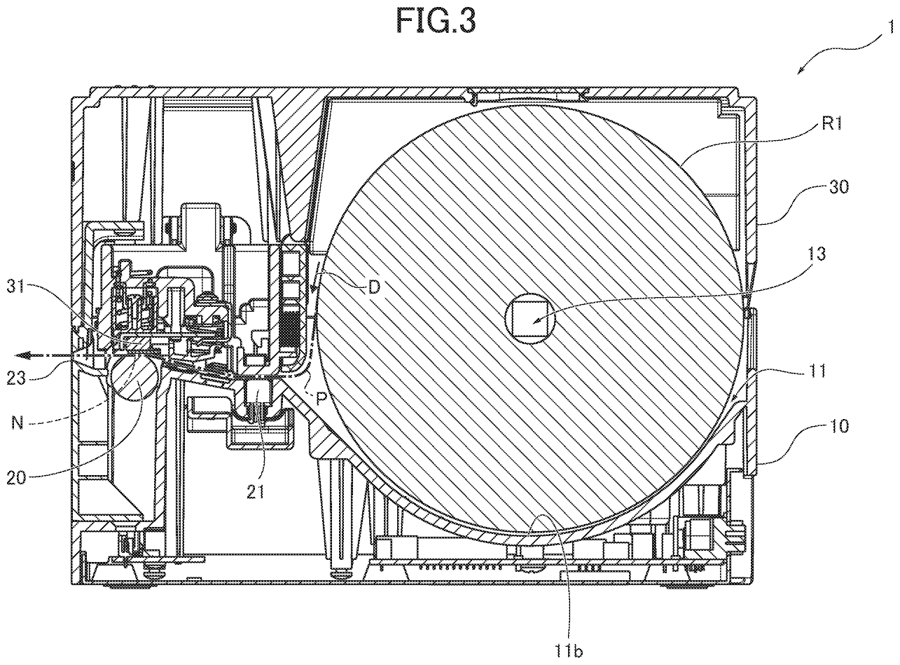

(Configuration of Image Forming Device without Attachment) FIG. 1 is a perspective view illustrating the image forming device according to the first embodiment when a cover is closed. FIG. 2 is a perspective view illustrating the image forming device according to the first embodiment without an attachment when the cover is opened. FIG. 3 is a cross-sectional view illustrating the image forming device according to the first embodiment without the attachment. Hereinafter, the configuration of the image forming device according to the first embodiment without the attachment will be described with reference to FIGS. 1 to 3.

As shown in FIG. 1, the image forming device 1 includes a body 10 as a casing and a cover 30.

As shown in FIG. 2 and FIG. 3, the body 10 includes a first storage portion 11, a platen roller 20, and a recording medium detector 21.

The first storage portion 11 is formed in the body 10. An upper portion of the first storage portion 11 is open upward. A bottom surface 11b of the first storage portion 11 includes a curved surface which is concave downward. The first storage portion 11 includes side walls 11a extending in a direction perpendicular a feeding direction D of a paper P. Each of the side walls 11a includes a first shaft support portion 12 which is formed in a concave shape. The first shaft support portions 12 support a primary or first shaft 13.

The first shaft (i.e. primary shaft) 13 includes a first shaft body 13a and first shaft protrusions 13b.

The first shaft body 13a is formed in a rectangular parallelepiped. The first shaft body 13a receives a label roll paper (first roll paper) R1. The label roll paper R1 includes a plurality of labels attached on a paper mount having a belt shape.

The first shaft protrusions 13b extend from longitudinal ends of the first shaft body 13a, respectively. The first shaft protrusions 13b detachably fit to the first shaft support portions 12. Accordingly, the label roll paper R1 set to the first shaft 13 is detachably stored in the first storage portion 11. The label roll paper R1 set to the first storage portion 11 provides the paper P as a recording medium.

The first shaft body 13a is attached with a position regulating plate 15 attached thereto. The position regulating plate 15 includes a regulating plate body 16 and a tubular protruding portion 17.

The regulating plate body 16 is formed in a plate. The tubular protruding portion 17 is formed in a tubular shape. The tubular protruding portion 17 is formed on the regulating plate body 16 to protrude from the regulating plate body 16. The inner diameter of the tubular protruding portion 17 is substantially the same as the outer diameter of the first shaft body 13a in size. The tubular protruding portion 17 receives the first shaft body 13a.

The position regulating plate 15 supports the label roll paper R1 in the first storage portion 11 from a side thereof so that the label roll paper R1 is properly placed at a predetermined position in an axial direction thereof.

With the position regulating plate 15 including tubular protruding portion 17, the thickness of the regulating plate body 16 can be reduced and the position regulating plate 15 can be prevented from rattling relative to the first shaft 13.

The recording medium detector 21 is provided downstream of the label roll paper R1 in the feeding direction D of the paper P. The recording medium detector 21 is configured to detect a reference position of the paper P such as a black mark printed on the paper P and to detect the existence of the paper P.

The platen roller 20 is provided downstream of the recording medium detector 21 in the feeding direction D of the paper P. The platen roller 20 is configured to support the backside of the paper P supplied from the label roll paper R1 during an image forming operation.

The cover 30 includes a thermal head portion 31. The thermal head portion 31 is provided to face the platen roller 20 when the cover 30 is closed. The thermal head portion 31 is biased in a direction to abut the platen roller 20 and forms a nipping portion N. The thermal head portion 31 is configured to perform thermal printing on the paper P at the nipping portion N.

In the image forming device 1 as configured above, the paper P is supplied to the nipping portion N from the label roll paper R1. The thermal head portion 31 performs the thermal printing on the paper P supplied to the nipping portion N based on the detection result of the recording medium detector 21. After the thermal printing, the paper P is output through a paper output portion 23.

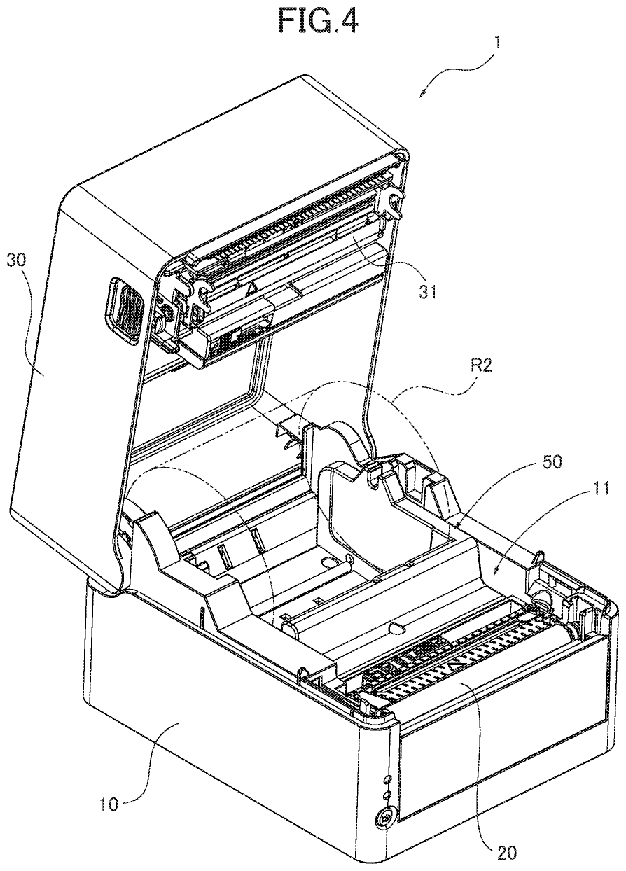

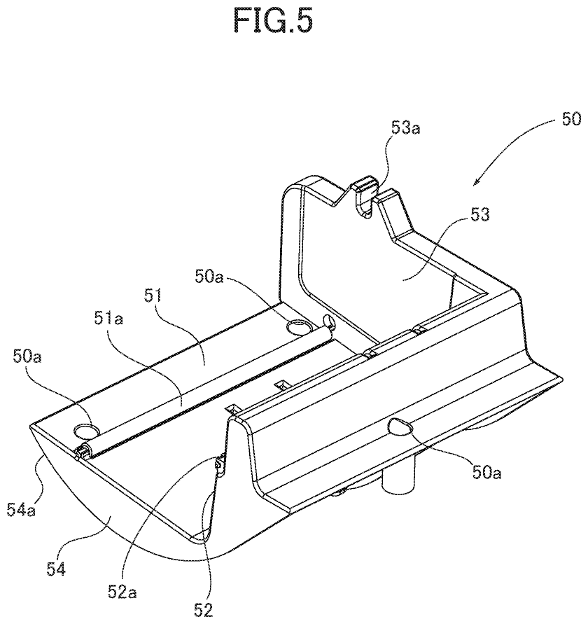

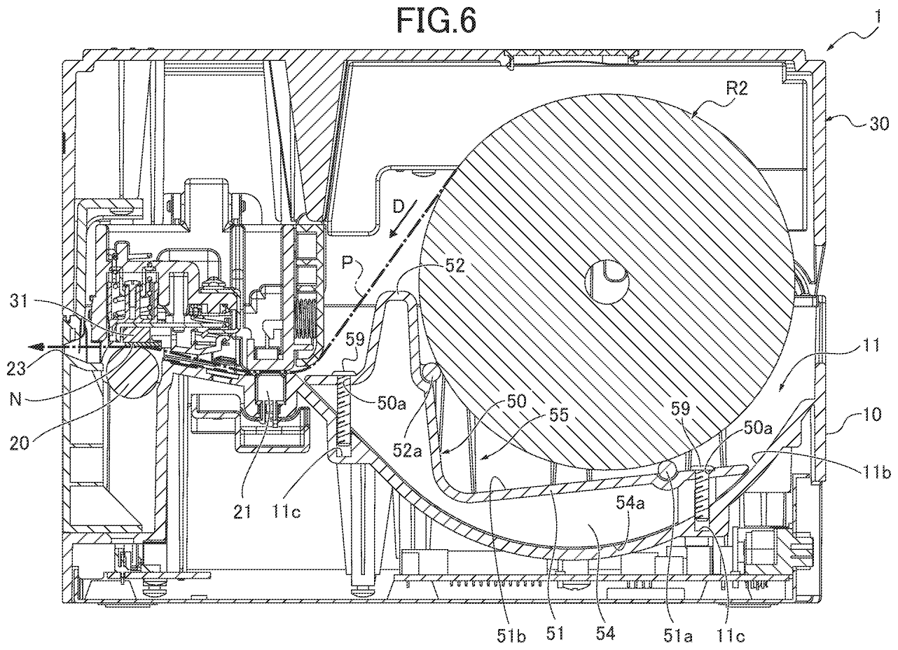

(Configuration of Image Forming Device with Attachment) FIG. 4 is a perspective view illustrating the image forming device according to the first embodiment with the attachment when the cover is opened. FIG. 5 is a perspective view illustrating the configuration of the attachment according to the first embodiment. FIG. 6 is a cross-sectional view illustrating the configuration of the image forming device according to the first embodiment with the attachment. Hereinafter, the configuration of the image forming device according to the first embodiment with the attachment will be described with reference to FIGS. 4 to 6.

As shown in FIG. 4, in the state that the attachment 50 is attached to the image forming device 1, the first shaft 13 is removed from the first storage portion 11 and the attachment 50 is attached to the first storage portion 11 as a supporting member.

As shown in FIG. 5 and FIG. 6, the attachment 50 includes a bottom portion 51 as a mounting portion, a front wall 52 as a front support portion, a side wall 53, and a flange 54.

The bottom portion 51 is configured to support a bottom part of the outer circumference surface of a normal roll paper (second roll paper) R2, which is described below, when the normal roll paper R2 is mounted on the bottom portion 51 of the attachment 50. The bottom portion 51 includes an inclined surface 51b inclined downward in the feeding direction of the normal roll paper R2. In other words, the inclined surface 51b is inclined downward in a rolling direction where the normal roll paper R2 moves (i.e. rolls) when unwound to supply the paper P.

The bottom portion 51 includes a support roller 51a. The support roller 51a is a rotatable roller which upwardly protrudes from the inclined surface 51b of the bottom portion 51.

The front wall 52 extends upward at the front side of the bottom portion 51 in a state that the attachment 50 is attached to the first storage portion 11. In other words, the front wall 52 is placed at a position to restrict the rolling (or moving) of the normal roll paper (second roll paper) R2 when the normal roll paper R2 is mounted on the bottom portion 51 of the attachment 50 and unwound to supply the paper P. The front wall 52 is configured to support a front part of the outer circumference surface of the normal roll paper R2 in the feeding direction (the rolling direction) of the normal roll paper R2.

The front wall 52 includes a support roller 52a. The support roller 52a is a rotatable roller which rearwardly protrudes from the surface of the front wall 52.

The side wall 53 extends from the bottom portion 51 or the front wall 52 at the side end thereof.

The flange 54 extends downwardly from the side ends of the bottom portion 51 and the front wall 52. Bottom portions 54a of the flange 54 is formed to correspond to the shape of the bottom surface 11b of the first storage portion 11.

The attachment 50 includes three through-holes 50a. Two of the through-holes 50a are provided rearward of the support roller 51a in the bottom portion 51. The other through-hole 50a is provided forward of the front wall 52. In other words, the three through-holes 50a are provided at positions not to prevent the supply of the paper P from the normal roll paper R2 when the normal roll paper (second roll paper) R2 is set in the attachment 50.

The first storage portion 11 includes three non-through-holes 11c. The three non-through-holes 11c are provided at positions corresponding to the three through-holes 50a of the attachment 50 when the attachment 50 is attached to the first storage portion 11.

When attaching the attachment 50 to the first storage portion 11, the attachment 50 is first placed in the first storage portion 11. Then, fasteners 59 such as screws are inserted from the upper side of the attachment 50 through the through-holes 50a of the attachment 50 and screwed into the non-through-holes 11c of the first storage portion 11 so that the attachment 50 is attached to the first storage portion 11.

Providing the non-through-holes 11c in the first storage portion 11 prevents elements such as a circuit board disposed under the first storage portion 11 from being seen by a user.

In the state that the attachment 50 is attached to the first storage portion 11, the bottom portion 51, the front wall 52, the side wall 53, and the side wall 11a of the first storage portion 11 define an area which forms a second roll paper storage 55 for the normal roll paper R2. The normal roll paper R2 is formed from a thermal paper wound in a roll.

The second roll paper storage 55 stores the normal roll paper R2. The outer circumferential surface of the normal roll paper R2 is supported by the support roller 51a in the bottom portion 51 and the support roller 52a in the front wall 52. The normal roll paper R2 set in the second roll paper storage 55 supplies the paper P as the recording medium.

In the image forming device 1 as configured above, the paper P is supplied to the nipping portion N from the normal roll paper R2. The thermal head portion 31 performs the thermal printing on the paper P supplied to the nipping portion N based on the detection result of the recording medium detector 21. After the thermal printing, the paper P exits through the paper output portion 23.

The normal roll paper R2 is supported by the support roller 51a in the bottom portion 51 and the support roller 52a in the front wall 52 when the outer diameter of the normal roll paper R2 is relatively larger. On the other hand, the normal roll paper R2 is supported by the inclined surface 51b of the bottom portion 51 and the support roller 52a in the front wall 52 or the surface of the front wall 52 when the paper P has been unwound from the normal roll paper R2 and the outer diameter of the normal roll paper R2 becomes relatively smaller.

Accordingly, when the normal roll paper R2 has a relatively large outer diameter and is relatively heavy, the normal roll paper R2 is smoothly rotated by the support roller 51a in the bottom portion 51 and the support roller 52a in the front wall 52 so that the paper P is supplied. On the other hand, when the normal roll paper R2 has a relatively small outer diameter and is relatively light, the normal roll paper R2 is smoothly rotated by the inclined surface 51b of the bottom portion 51 and the support roller 52a in the front wall 52 or the surface of the front wall 52 so that the paper P is supplied.

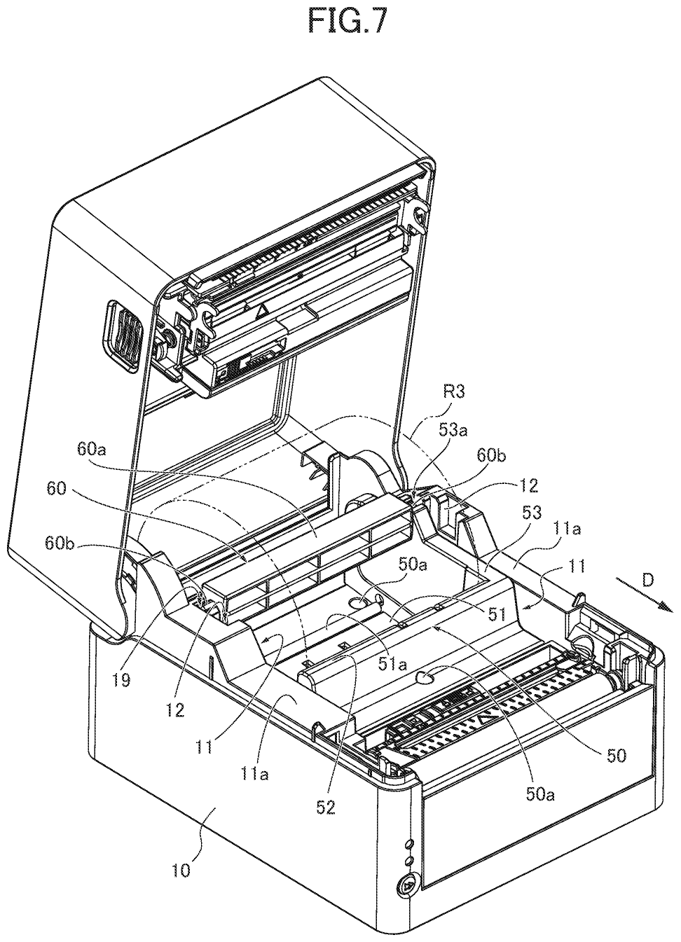

(Configuration of Auxiliary Shaft) FIG. 7 is a perspective view illustrating a second or auxiliary shaft according to the first embodiment. Hereinafter, the configuration of the auxiliary shaft according to the first embodiment will be described with reference to FIG. 7.

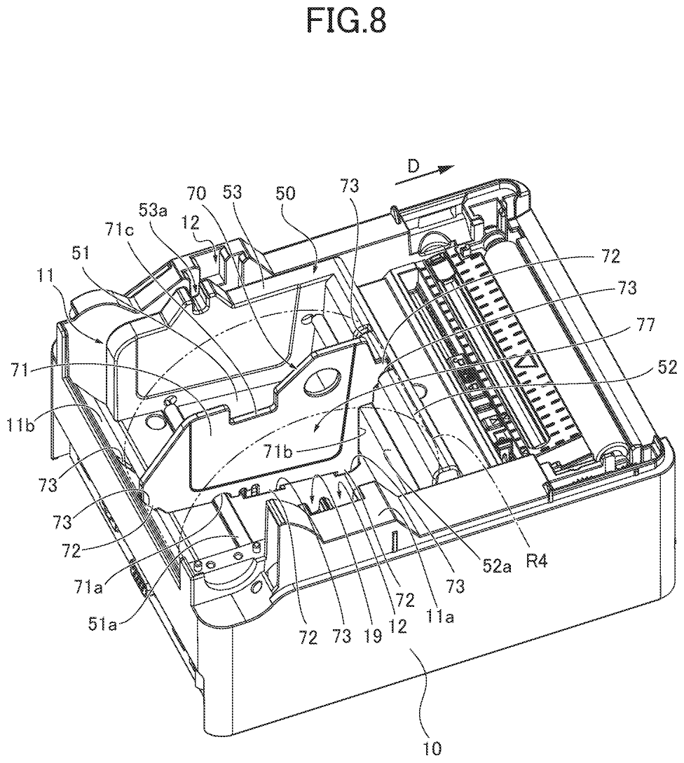

The side wall 11a of the first storage portion 11 includes a second auxiliary shaft supporting portion 19 provided rearward of the first shaft support portions 12 (see FIG. 8). The second auxiliary shaft supporting portion 19 is formed in a concave shape. The side wall 53 of the attachment 50 includes a first auxiliary shaft supporting portion 53a which is formed in a concave shape (see also FIG. 8). The auxiliary shaft supporting portions 19, 53a are formed smaller than the first shaft support portions 12 and configured to support the second or auxiliary shaft 60. Specifically, the attachment 50 supports one end of the auxiliary shaft 60 while the body 10 supports the other end of the auxiliary shaft 60.

The auxiliary shaft 60 includes an auxiliary shaft body 60a and auxiliary shaft protrusions 60b.

The auxiliary shaft body 60a formed in a rectangular parallelepiped. The auxiliary shaft body 60a receives a label roll paper (third roll paper) R3. The label roll paper R3 includes a plurality of labels attached on a paper mount having a belt shape. The label roll paper R3 is smaller than the label roll paper R1.

The auxiliary shaft protrusions 60b extend from longitudinal ends of the auxiliary shaft body 60a, respectively. The auxiliary shaft protrusions 60b are smaller than the first shaft protrusions 13b. The first shaft protrusions 13b detachably fit into the auxiliary shaft supporting portions 19, 53a. Accordingly, the label roll paper R3 set to the auxiliary shaft 60 is detachably stored in the second roll paper storage 55. The label roll paper R3 set to the second roll paper storage 55 supplies the paper P as the recording medium.

Having the auxiliary shaft supporting portions 19, 53a smaller than the first shaft support portions 12 can prevent the improper attachment of the first shaft 13 and the auxiliary shaft 60.

In the image forming device 1 as configured above, the paper P is supplied to the nipping portion N from the label roll paper R3. The thermal head portion 31 performs the thermal printing on the paper P supplied to the nipping portion N based on the detection result of the recording medium detector 21. After the thermal printing, the paper P exits through the paper output portion 23.

(Configuration of Partition Plate) FIG. 8 is a perspective view illustrating a partition plate according to the first embodiment. Hereinafter, the configuration of the partition plate will be described with reference to FIG. 8.

The partition plate 70 as a positioning member includes a partition plate body 71 and a plurality of engaging protrusions 72.

The partition plate body 71 is formed in a plate shape. The engaging protrusions 72 protrude from the outer circumference of the partition plate body 71.

The engaging protrusions 72 engage with engaging grooves 73. The engaging grooves 73 are provided in the bottom portion 51 and the front wall 52 of the attachment 50, and the bottom surface 11b of the first storage portion 11.

The engagement of the engaging protrusions 72 with the engaging grooves 73 allows the detachable attachment of the partition plate 70 to the attachment 50.

The partition plate body 71 includes a first notch 71a and a second notch 71b. The first notch 71a is provided at a position corresponding to the position where the support roller 51a is provided in the bottom portion 51. The second notch 71b is provided at a position corresponding to the position where the support roller 52a is provided in the front wall 52.

Accordingly, the partition plate 70 does not prevent the rotation of the support roller 51a in the bottom portion 51 and the rotation of the support roller 52a in the front wall 52 when the partition plate 70 is attached to the attachment 50.

In the state that the partition plate 70 is attached to the attachment 50, the bottom portion 51, the front wall 52, the side wall 11a of the first storage portion 11, and the partition plate 70 defines an area which forms a third roll paper storage portion 77 for a normal roll paper R4. The normal roll paper R4 is formed of a thermal paper wound in a roll.

The third roll paper storage portion 77 is configured to store the normal roll paper R4 which is narrower than the normal roll paper R2 in width. The outer circumferential surface of the normal roll paper R4 is supported by the support roller 51a in the bottom portion 51 and the support roller 52a in the front wall 52. The partition plate 70 regulates the position of the normal roll paper R4 in the width direction. The normal roll paper R4 in the third roll paper storage portion 77 supplies the paper P as the recording medium.

In the image forming device 1 as configured above, the paper P is supplied to the nipping portion N from the normal roll paper R4. The thermal head portion 31 performs the thermal printing on the paper P supplied to the nipping portion N based on the detection result of the recording medium detector 21. After the thermal printing, the paper P exits through the paper output portion 23.

The normal roll paper R4 is supported by the support roller 51a in the bottom portion 51 and the support roller 52a in the front wall 52 when the outer diameter of the normal roll paper R4 is relatively larger. On the other hand, the normal roll paper R4 is supported by the upper surface of the bottom portion 51 and the support roller 52a in the front wall 52 or the surface of the front wall 52 when the paper P has been unwound from the normal roll paper R4 and the outer diameter of the normal roll paper R4 becomes relatively small.

Accordingly, when the normal roll paper R4 has a relatively large outer diameter and is relatively heavy, the normal roll paper R4 is smoothly rotated by the support roller 51a in the bottom portion 51 and the support roller 52a in the front wall 52 so that the paper P is supplied. On the other hand, when the normal roll paper R4 has a relatively small outer diameter and is relatively light, the normal roll paper R4 is smoothly rotated by the inclined surface 51b of the bottom portion 51, and the support roller 52a in the front wall 52 or the surface of the front wall 52 so that the paper P is supplied.

It should be noted that a label roll narrower than the label roll paper R3 set to the auxiliary shaft 60 may be set to the third roll paper storage portion 77 in the state that the partition plate 70 is attached to the attachment 50.

In this case, the partition plate body 71 includes a third notch 71c. The third notch 71c is formed so that the partition plate body 71 does not interfere with the auxiliary shaft supported by the shaft supporting portions 19, 53a.

(Modification) The image forming device may include a static elimination brush in the vicinity of the paper output portion 23 as a static elimination member that eliminates static electricity from the paper P. However, when the static elimination brush is installed in the body 10 with the tip of the static elimination brush facing upward, the tip of the static elimination brush is noticeable, which causes undesirable appearance.

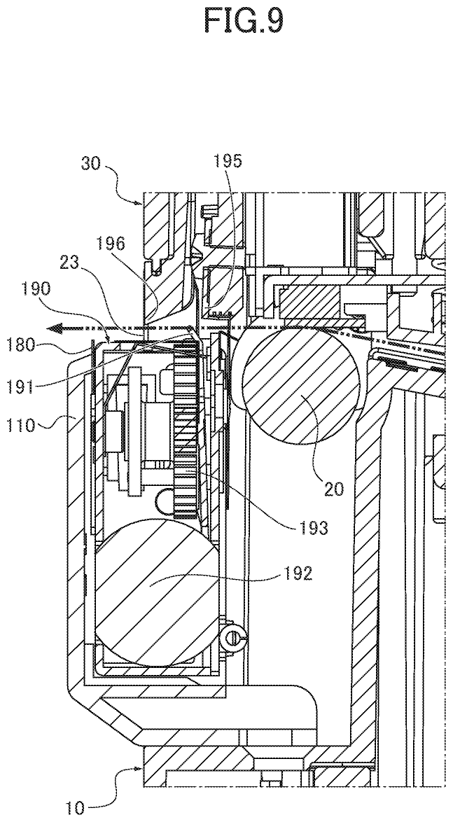

Considering the above, the image forming device includes a static elimination sheet as the static elimination member. FIG. 9 is a cross-sectional view illustrating the static elimination sheet according to the modification of the first embodiment.

An image forming device 101 according to the modification of the first embodiment differs from the image forming device 1 according to the first embodiment in that the image forming device 101 includes a cutter portion 190, a first fixed blade 195, a static elimination sheet 180, a cutter cover 110, and a second fixed blade 196.

The cutter portion 190 is provided in the body 10 downstream of the platen roller 20 in the feeding direction D of the paper P. The cutter portion 190 includes a movable blade 191. The movable blade 191 is connected to a motor 192, which is a drive source, via a gear 193 to move vertically.

The first fixed blade 195 is provided in the cover 30. The first fixed blade 195 faces the movable blade 191 when the cover 30 is closed.

The static elimination sheet 180 is provided in the body 10 downstream of the cutter portion 190 in the feeding direction D of the paper P. The static elimination sheet 180 is made of non-woven fabric, for example. The static elimination sheet 180 is provided entirely along the paper output portion 23 and extends in a direction perpendicular to the feeding direction D of the paper P. The static elimination sheet 180 is attached to an outer wall surface of the cutter portion 190 with a fastener such as a double-sided tape with an upper end of the static elimination sheet 180 extending from the upper surface of the cutter portion 190. The static elimination sheet 180 is configured to eliminate static electricity from the paper P ejected from the paper output portion 23.

The cutter cover 110 is provided in the body 10 downstream of the static elimination sheet 180 in the feeding direction D of the paper P. The static elimination sheet 180 is fixed between the cutter portion 190 and the cutter cover 110.

The second fixed blade 196 is provided in the cover 30 downstream of the first fixed blade in the feeding direction D of the paper P.

In the image forming device 101 as configured above, the static elimination sheet 180 eliminates static electricity from the paper P ejected from the paper output portion 23. Further, the movable blade 191 automatically cuts the paper P ejected from the paper output portion 23 by moving toward the first fixed blade while the paper P exists between the movable blade 191 and the first fixed blade. Alternatively, the user may cut the paper P by pulling and pressing the paper P against the second fixed blade 196.

Now, the operation of the roll paper storage structure and the image forming device according to the first embodiment is described.

(Comparative Operations) For example, in a comparative example, an image forming device for a label roll paper and an image forming device for a normal roll paper are manufactured, respectively.

The comparative example requires two different image forming devices respectively manufactured. One is the image forming device for the label roll paper which includes the roll paper storage portion to store the label roll paper. The other is the image forming device for the normal roll paper which includes the roll paper storage portion to store the normal roll paper. Consequently, the elements or parts cannot be commonly used for both of the image forming devices and accordingly management for the elements or parts is more complicated.

On the other hand, the roll paper storage structure and the image forming device 1 according to the first embodiment include the casing (body 10) configured to detachably support the first shaft 13 to which the first roll paper (label roll paper R1) is set, the first storage portion 11 provided in the casing (body 10) and configured to store at least a part of the first roll paper (label roll paper R1) set to the first shaft 13, and the supporting member (attachment 50) configured to be attachable to the first storage portion 11 and to support the outer circumferential surface of the second roll paper (normal roll paper R2) that is not set to the first shaft 13 (see FIG. 6).

Accordingly, the image forming device is manufactured without the attachment 50 when the label roll paper R1 is used, while the image forming device is manufactured with the attachment 50 attached to the first storage portion 11 when the normal roll paper R2 is used. Therefore, the image forming device 1 has a simple configuration corresponding to both of the label roll paper R1 and the normal roll paper R2 and the elements or parts other than the attachment 50 can be commonly used for both cases.

In the roll paper storage structure and the image forming device 1 according to the first embodiment, the supporting member (attachment 50) includes the mounting portion (bottom portion 51) configured to support the bottom part of the outer circumferential surface of the second roll paper (normal roll paper R2), and the front support portion (front wall 52) configured to support the front part of the outer circumferential surface of the second roll paper (normal roll paper R2) in the feeding direction (rolling direction) of the second roll paper (see FIG. 6).

Accordingly, the normal roll paper R2 is supported by the bottom portion 51 and the front wall 52 when the normal roll paper R2 rotates to supply the paper P from the normal roll paper R2. Consequently, the paper P can be stably supplied from the normal roll paper R2.

In the roll paper storage structure and the image forming device 1 according to the first embodiment, the mounting portion (bottom portion 51) includes the inclined surface 51b inclined downward in the feeding direction (rolling direction) of the second roll paper (see FIG. 6).

Accordingly, the normal roll paper R2 can be properly set to a predetermined position even if the normal roll paper R2 is placed in a position deviated from the predetermined position, for example. Consequently, the paper P can be stably supplied from the normal roll paper R2.

The roll paper storage structure and the image forming device 1 according to the first embodiment include the positioning member (partition plate 70) configured to regulate the position of the second roll paper (normal roll paper R2) in the width direction. The positioning member (partition plate 70) is configured to be detachably attached to the supporting member (attachment 50) (see FIG. 8).

Accordingly, the plurality of roll papers having different widths can be stored in the storage portion defined by the attachment 50. Consequently, the plurality of roll papers having different widths can be used.

The roll paper storage structure and the image forming device 1 according to the first embodiment include the auxiliary shaft 60 detachably supported by the supporting member (attachment 50). The third roll paper (label roll paper R3) set to the auxiliary shaft 60 is stored in the supporting member (attachment 50) (see FIG. 7).

Accordingly, the label roll paper R3 can be set to the auxiliary shaft 60 even when the attachment 50 is attached to the first storage portion 11. Consequently, the use of the normal roll paper R2 and the label roll paper R3 can be achieved with the simple configuration.

The roll paper storage structure and the image forming device 1 according to the first embodiment include the first auxiliary shaft supporting portion 53a provided in the supporting member (attachment 50) and configured to support one end of the auxiliary shaft 60, and the second auxiliary shaft supporting portion 19 provided in the casing (body 10) and configured to support the other end of the auxiliary shaft 60 (see FIG. 7).

Accordingly, it is unnecessary for the attachment 50 to include one of the side walls. Consequently, a wider space can be secured when the attachment 50 is attached to the first storage portion 11. Further, the weight of the image forming device 1 can be reduced.

In the roll paper storage structure and the image forming device 1 according to the first embodiment, the supporting member (attachment 50) includes the through-holes 50a and the casing (body 10) includes the non-through-holes 11c. The supporting member (attachment 50) is fixed to the casing (body 10) by the fasteners 59 via the through-holes 50a and the non-through-holes 11c (see FIG. 6).

Accordingly, the inside of the body 10 cannot be seen through the non-through-holes 11c provided in the first storage portion 11 of the body 10 when the attachment 50 is not attached to the first storage portion 11. Consequently, it is unnecessary to provide parts such as masking screws into the non-through-holes 11c provide in the first storage portion 11 of the body 10.

### Second Embodiment

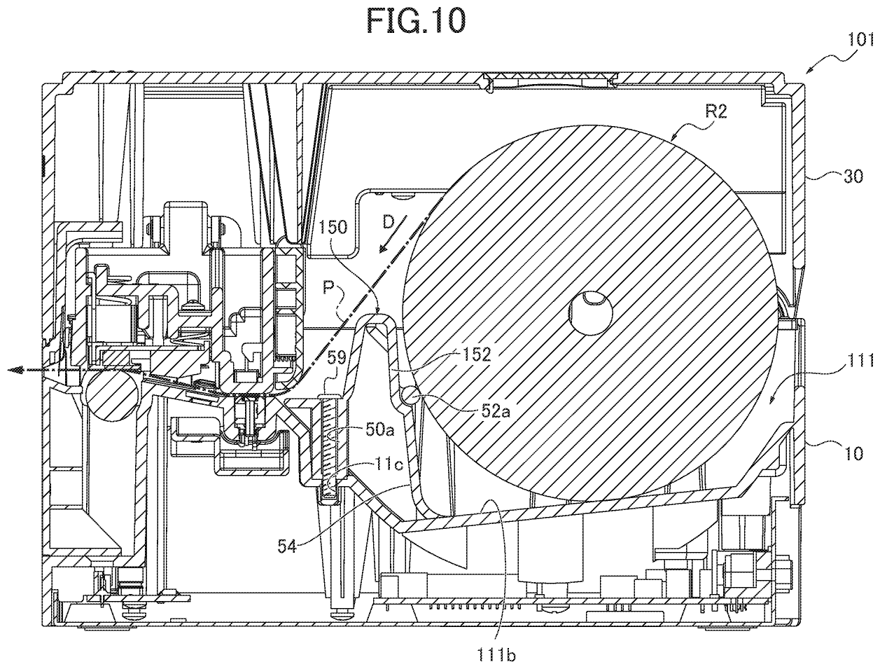

The configuration of a second embodiment will be described. FIG. 10 is a cross-sectional view illustrating an image forming device according to the second embodiment with an attachment. It should be noted that the same terms and reference numerals are used for the same or equivalent parts as those used in the first embodiment for the explanation of the second embodiment.

In a roll paper storage structure and the image forming device according to the second embodiment, an inclined surface is provided in the first storage portion. The image forming device in the second embodiment differs from the image forming device in the first embodiment in that the configurations of the first storage portion and the attachment differ from those in the first embodiment.

(Configuration of First Storage Portion) As shown in FIG. 10, a bottom surface 111b of the first storage portion 111 includes the inclined surface. The inclined surface is inclined downward in the feeding direction of the normal roll paper R2. In other words, the inclined surface is inclined downward in the rolling direction where the normal roll paper R2 moves (i.e. rolls) when unwound to supply the paper P.

(Configuration of Attachment) An attachment (support portion) 150 includes a front wall 152 as a front support portion.

The front wall 152 extends upward at the front side of the bottom surface 111b of the first storage portion 111. In other words, the front wall 152 is placed at a position to restrict the rolling (or moving) of the normal roll paper (second roll paper) R2 when the normal roll paper R2 is mounted on the bottom surface 111b of the first storage portion 111 and unwound to supply the paper P.

Hereinafter, the operation of the roll paper storage structure and the image forming device according to the second embodiment will be described.

In the image forming device 101 as configured above, the label roll paper R1 set to the first shaft 13 is stored in the first storage portion 111 when the attachment 150 is not attached.

On the other hand, when the attachment 150 is used, the first shaft 13 is removed from the first storage portion 111, the attachment 150 is attached to the first storage portion 111, and then the normal roll paper R2 is set in the first storage portion 111 with the attachment 150. Specifically, the normal roll paper R2 is stored in the first storage portion 111 with the attachment 150 attached thereto and the outer circumferential surface of the normal roll paper R2 is supported by the front wall 152 of the attachment 150 and the bottom surface 111b of the first storage portion 111.

The attachment 150 is placed in a position where the attachment 150 does not overlap the first shaft 13 in a plane when viewing the body 10 from the cover 30 side. Accordingly, the attachment 150 can be attached to the first storage portion 111 even when the first shaft 13 is set to the first storage portion 111. In this case, it is only required to remove the first shaft 13 from the first storage portion 111 before the normal roll paper R2 is set in the first storage portion 111.

Consequently, the image forming device 101 has a simple configuration corresponding to both of the label roll paper R1 and the normal roll paper R2 and the elements or parts other than the attachment 150 can be commonly used for both cases.

The roll paper storage structure and the image forming device according to the present disclosure have been illustrated with reference to the first and second embodiments. However, the specific configurations described above are not limited to the embodiments shown in the figures, but combinations of the embodiments, design changes, additions or the like are allowed without departing from the scope of the inventions recited in following claims.

In the first and second embodiments, the roll paper storage structure and the image forming device are applied to the thermal printer. However, the roll paper storage structure and image forming device may be applied to an image forming device such as an impact printer, a laser printer, an ink-jet printer, a plotter, a word processor, a facsimile, a copier, or a multi-function image forming device that includes functions of at least two of the above.

1. A roll paper storage structure comprising:
a casing comprising a first shaft support portion, the first shaft support portion configured to detachably support a first shaft to which a first roll paper is set;
a first storage portion provided in the casing and configured to store at least a part of the first roll paper set to the first shaft; and
a supporting member configured to support an outer circumferential surface of a second roll paper that is not set to the first shaft and to store at least a part of the second roll paper,
wherein the support member is configured to be attachable to the first storage portion when the first shaft is removed from the first shaft support portion.

2. The roll paper storage structure according to claim 1, wherein the supporting member comprises:
a mounting portion configured to support a bottom part of an outer circumferential surface of the second roll paper; and
a front support portion configured to support a front part of the outer circumferential surface of the second roll paper in a direction of rolling of the second roll paper by a rotation of the second roll paper.

3. (canceled)

4. The roll paper storage structure according to claim 1, further comprising a positioning member configured to regulate a position of the second roll paper in a width direction,
wherein the positioning member is configured to be detachably attached to the supporting member.

5. The roll paper storage structure according to claim 1, further comprising an auxiliary shaft detachably supported by the supporting member,
wherein a third roll paper set to the auxiliary shaft is stored in the supporting member.

6. The roll paper storage structure according to claim 5, further comprising:
a first auxiliary shaft supporting portion provided in the supporting member and configured to support one end of the auxiliary shaft, and
a second auxiliary shaft supporting portion provided in the casing and configured to support an other end of the auxiliary shaft.

7. The roll paper storage structure according to claim 1,
wherein the supporting member comprises a through-hole and the casing comprises a non-through-hole, and
wherein the supporting member is configured to be fixed to the casing by a fastener via the through-hole and the non-through-hole.

8. An image forming device comprising the roll paper storage structure according to claim 1.

9. The roll paper storage structure according to claim 1,
wherein a bottom surface of the first storage portion is formed in a concave shape, and
wherein a bottom portion of the supporting member comprises an inclined surface inclined downward in the feeding direction of the second roll paper.

10. The roll paper storage structure according to claim 1, wherein a bottom portion of the supporting member comprises a support roller for supporting the second roll paper.

11. The roll paper storage structure according to claim 1, wherein a front wall of the supporting member comprises a support roller for supporting the second roll paper.

12. The roll paper storage structure according to claim 1, wherein a storage space of the supporting member for storing the second roll paper is located closer to a bottom surface of the first storage portion than the first shaft support portion.

13. The roll paper storage structure according to claim 1, wherein the supporting member is configured to be detachable to a bottom surface of the first storage portion.

14. The roll paper storage structure according to claim 1, wherein a bottom portion of the supporting member comprises a portion with a contour along a bottom surface of the first storage portion.
